(19) United States
(12) Patent Application Publication
(10) Pub. No.: US 2021/0178624 A1
(43) Pub. Date: Jun. 17, 2021

(54) POSITIONING PIN FOR DIE COUNTERPLATE

(71) Applicant: Kazuaki Asai, Kanazawa-shi, Ishikawa (JP)

(72) Inventors: Mark Goldsmith, York (GB); Oliver Arnedo, Knaresborough (GB)

(21) Appl. No.: 16/322,993

(22) PCT Filed: Aug. 3, 2017
(86) PCT No.: PCT/GB2017/052268

§ 371 Date: Feb. 4, 2019

(30) Foreign Application Priority Data
Aug. 4, 2016 (GB) 1613465.2

(51) Int. Cl. B26F 1/44

(52) U.S. Cl. CPC B26F 1/44; B26F 2001/4463

(57) ABSTRACT

There is disclosed an alignment device for aligning a counterplate with a die plate. The alignment assembly comprises an elongate alignment pin, the pin being disposed in a mounting body; a spacer member, comprising a spacer portion and a retaining portion for retaining the spacer member to the assembly. The alignment pin, spacer member and/or mounting body are configured such that the pin can be retained in the mounting body in a first, extended, position, and in a second, retracted, position; and the spacer member is preferably retained to the assembly in both the extended and retracted positions of the pin. The pin is also configured to be drawn into an extended position by a setting tool for alignment of the counterplate relative to the die.

### FIELD OF THE INVENTION

The present invention relates to apparatus and related methods for the set-up of a die and counterplate for cut and crease forming operations. In particular, the invention relates to a novel alignment pin which reduces time and operations required in the set-up of a die and counterplate in such operations.

### BACKGROUND TO THE INVENTION

Cut and crease forming operations, for creating foldable nets for folded items, are well known and are carried out typically with a die and a counterplate. The die will carry a series of sharp or blunt blades, each configured to cut and/or crease selected regions of a planar sheet placed between the die and counterplate, to create a net for e.g. a box or other cut and folded item, for example containers, envelopes, point of sale display stands or other packaging related material. The process relies on the blades on the die being properly aligned with slots or recesses on an appropriate counterplate. This is to ensure that the blades can appropriately cut or crease the blank due to their force and shape being applied to the blank and being properly countered by an opposing feature on the counterplate. A die and counterplate pair is therefore unique to a particular form of a net to be produced from the blank. For each manufacturing run requiring a new die, a new counterplate must be aligned with the die. This is generally achieved by providing a counterplate with an adhesive back, to be aligned in the forming machine and pressed onto the carrier for the counterplate by action of the machine bringing the die into contact with the counterplate.

An example of steps in a process for setting up a die and counterplate is illustrated in FIGS. 1A to 1D.

In FIG. 1A a counterplate alignment pin 10 is provided in a die board 1. A resilient spacer 11 is placed around a protruding end of the alignment pin 10, with the alignment pin 10 standing proud of the die board 1 and the spacer 11.

As shown in FIG. 1B, the counterplate 3 is located over the blades 12 and 13. As is known in the art, blades 12 and 13 are configured to either be sharp, in order to cut a sheet placed between the blade and the counterplate 3, or to have a generally curved outer edge, to crease a sheet placed between the blade and the counterplate 3, to allow easy folding along the crease. As will be appreciated, although only one alignment pin 10 and spacer 11 is shown, and a sub-section of the die board 1 is shown, it will be appreciated that in a full operation, a plurality of alignment pins 10 will often be used in order to provide reliable two-dimensional alignment of the counterplate 3 relative to the die board 1. As illustrated in FIG. 1C, the die cutting machine is actuated to press the die board 1 and the counterplate board 4 together in a direction of arrows A and B. The side of the counterplate 3 facing the counterplate board 4 is self-adhesive; a covering layer is generally removed before the counterplate is pressed onto the counterplate board 4. When the die board 1 and counterplate board 4 are pressed together, then the counterplate is stuck to the counterplate board 4 via its adhesive back. Compression of the die board 1 and counterplate board 4 together both causes adhesion of the counterplate to the counterplate board, and, also presses the alignment pin 10 back into the die board 1. This also compresses the counterplate 3 between the resilient spacer 11 and the counterplate board 4 in order to ensure local adhesion in the region of the alignment pin 10.

As shown in FIG. 1D, once the die board 1 and the counterplate board 4 are separated once more, the counterplate 3 remains adhered to the counterplate board 4 and the system is now ready for blanks to be provided between the blades 12, 13, and the counterplate 3 to manufacture foldable nets according to the blade and counterplate configuration put in place.

In standard known arrangements of the alignment pin 10 and resilient spacer 11, these components are simply provided in such a manner as to provide some resistance to movement to the alignment pin. During the pressing of the counterplate, the alignment pin is pushed back into the die board 1. If the alignment pin is required for alignment of a further counterplate for a new manufacturing run, it must be manually extended out of the die board. In past systems, this is commonly done by pushing out the alignment pin from a side of the die board opposite the blades (i.e. a back face of the die board). The resilient spacer 11 of previous systems is a generally loose element and so has to be removed from the die board manually before the manufacturing operation can begin. This is because the retraction of the alignment pin would leave the resilience spacer free and so the spacer must be removed to avoid interference with the manufacturing operations to follow. Carrying out operations from the back face of the die board in this way can be complex and there is, of course, the risk of the resilient spacers 11 not all being successfully retrieved, meaning that they could still cause a potential issue with later manufacturing operations.

There is therefore a need for improved configurations of alignment pins and/or resilient spacers for the counterplate alignment procedure described above.

### SUMMARY OF THE INVENTION

The invention relates to an alignment device which is configured to enable the alignment pin to be drawn into an extended position within a mounting body from a blade-side of a die board. The pin can be held in extended and retracted positions in the mounting body and can thus be extended for counterplate alignment operations and retracted into the die board during manufacturing operations. An integral spacer member is preferably incorporated into the device, which can be biased into an extended position with the alignment pin for alignment purposes and for pressing the counterplate onto a counterplate board during setup of the die and counterplate. Once a biasing force biasing the spacer member and/or pin into the extended position is overcome, both elements retract toward the die board and are retained thereto during manufacturing operations. For further alignment operations, the pin and spacer can be pulled away from the die board to their extended positions once more.

According to a first aspect of the invention, an alignment device is provided for aligning a counterplate with a die plate, comprising an alignment assembly, the alignment assembly comprising:
an elongate alignment pin having a first end, a second end and a longitudinal axis extending between the first and second ends;
a mounting body, the pin being disposed in the mounting body;
a spacer member, comprising:
   a spacer portion extending radially from the pin; and
   a retaining portion for retaining the spacer member to the assembly;
the alignment pin, spacer member and/or mounting body being configured such that the pin is retained in the sleeve or mounting body in a first, extended, position, and in a second, retracted, position;
wherein the spacer member is retained to the assembly in both the extended and retracted positions of the pin.

The device may be further configured to achieve any of the following features. When the alignment pin is arranged in the retracted position, the spacer member may be slideably retained to the assembly and is translatable along the longitudinal axis of the alignment pin.

When the alignment pin is arranged in the retracted position, the spacer member may be biased away from the mounting body.

When the alignment pin is arranged in the retracted position, the retaining portion of the spacer member may be configured to bias a first side of the spacer member away from the mounting body.

When the alignment pin is in its extended position, the spacer member may be held in substantially fixed position relative to the alignment pin and/or the mounting body.

The retaining portion of the spacer member may be configured to retain the spacer member to the assembly and to retain the pin within the, mounting body.

The retaining portion of the spacer member may be configured to be located radially between the alignment pin and the mounting body.

When arranged in the retracted position of the alignment pin, the retaining portion of the spacer member may be configured to bias the first side of the spacer member away from the mounting body by biasing against a first shoulder on the alignment pin.

When arranged in the extended position of the pin, the pin may be biased into the extended position by one or more biasing members of the mounting body acting on a second shoulder of the pin.

The retaining portion of the spacer member may be configured to retain the spacer member to the alignment pin.

The retaining portion of the spacer member may be configured to retain the spacer member to the alignment pin by a first substantially radially extending feature of the retaining portion engaging a corresponding substantially radially extending feature of the alignment pin.

The retaining portion of the spacer member may be configured to retain the spacer member to the alignment pin by a second substantially radially extending feature of the retaining portion engaging a corresponding substantially radially extending feature of the mounting body.

The spacer member and/or the alignment pin may comprise an engagement portion configured to be engaged by a setting tool to draw the spacer and/or alignment pin away from the mounting body to place the alignment pin in the extended position.

The alignment pin may comprise an engagement surface configured to be engaged by a setting tool to pull the alignment pin away from the mounting body to place the alignment pin in the extended position.

The spacer member may comprise secondary retaining means, configured to retain the assembly in the extended configuration.

The secondary retaining means may comprise at least one projection on the retaining member of the spacer member, configured to engage an engagement member of the mounting body.

A system comprising an alignment device according to any of the preceding claims, and a setting tool, configured to engage an engagement portion or surface of the alignment pin and/or the spacer member, to pull the alignment pin and/or spacer member into the extended position.

A setting tool for an alignment device according to the invention may comprise a longitudinal tool axis and at least one circumferentially projecting hook for engaging a mounting-body-facing surface of the spacer member to draw the spacer member away from the mounting body.

A setting tool for an alignment device according to the invention may comprise at least one inwardly projecting protrusion, configured to engage a recess on an outer surface of the alignment pin, to draw the alignment pin away from the mounting body to the extended position.

According to a further aspect, there is provided an alignment device for aligning a counterplate with a die plate, comprising an alignment assembly, the alignment assembly comprising:
an elongate alignment pin having a first end, a second end and a longitudinal axis extending between the first and second ends;
a mounting body, the pin being disposed in the mounting body;
the alignment pin and mounting body being configured such that the pin can be retained in the mounting body in a first, extended, position, and in a second, retracted, position;
wherein the alignment pin comprises an engagement surface configured to be engaged by a setting tool to pull the alignment pin away from the mounting body to place the alignment pin in the extended position A method of aligning a counter plate with a die for cut and crease manufacturing operations is further provided, comprising the steps of
a) providing one or more alignment devices projecting from a blade side of a die board, the alignment device comprising an alignment pin retained in a mounting, body, the pin and mounting body configured such that the pin can be retained in a first, extended, position, and in a second, retracted, position:
b) aligning a counterplate over the die by alignment with the alignment pin;
c) actuating a press to press the counterplate onto a counterplate board, the force of the press moving the alignment pin from its extended position to its retracted position; and
d) pulling the alignment pin from a blade side direction, to place it in its extended position, preferably after using the counter plate and die to cut and crease one or more sheets.

### BRIEF DESCRIPTION OF THE DRAWINGS

Embodiments of the invention will now be described with reference to the accompanying drawings, in which:

FIGS. 1A to 1D illustrate steps in a method of aligning a counterplate in which embodiments of the invention can be used.

FIGS. 2A to 2G illustrate a first embodiment of an alignment device and corresponding setting tool in accordance with the invention;

FIGS. 3A to 3H illustrate a second embodiment of an alignment device and corresponding setting tool according to the invention.

### DETAILED DESCRIPTION OF THE INVENTION

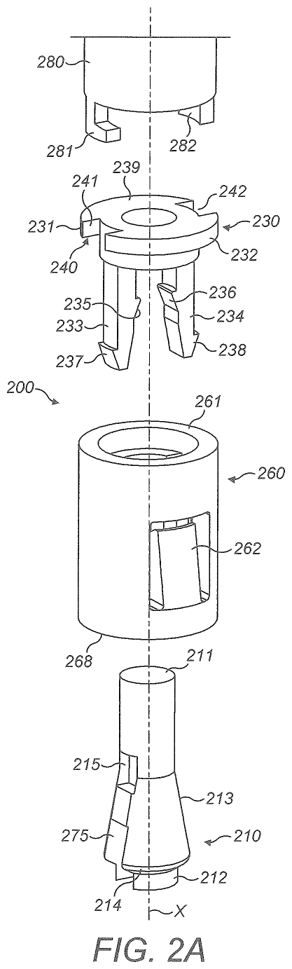

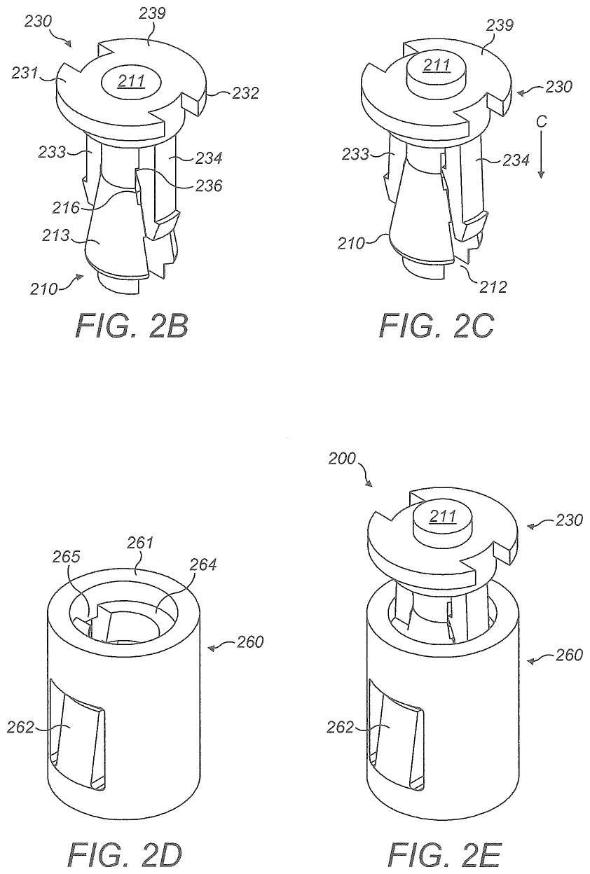

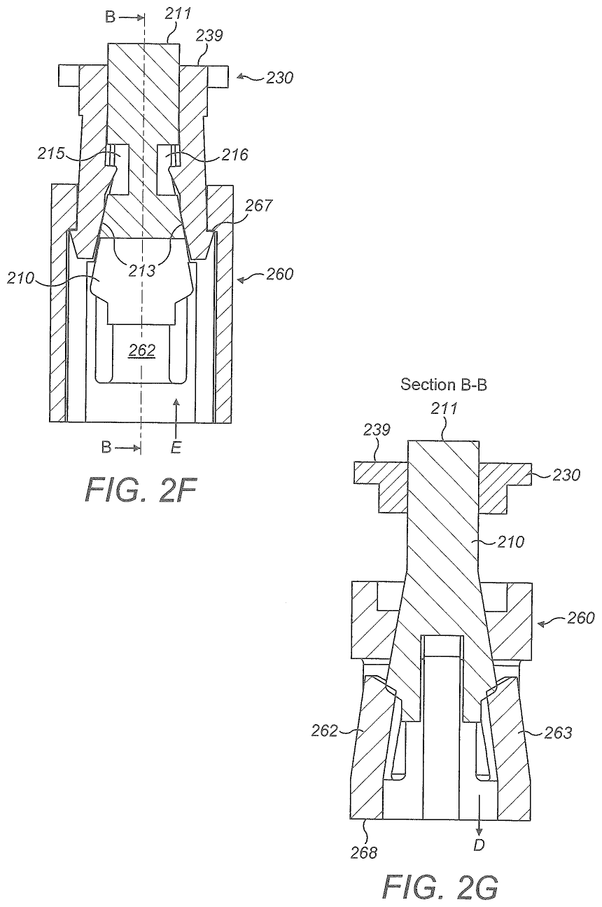

FIG. 2A shows a first embodiment of an alignment device according to the invention. The device 200 is assembled from a plurality of parts and generally comprises an alignment pin 210, a spacer member 230 and a mounting body 260. The alignment pin comprises a first end 211 and a second and second end 212, and has a longitudinal axis X extending therebetween. The pin comprises a first shoulder 213 and a second shoulder 214. The shoulder is a substantially radially-extending surface of the pin 210. It may not extend perpendicularly to axis X. For example, first shoulder 213, is oriented towards the first end 211, and extends away from the axis X at a first angle. Second shoulder 214 is oriented towards the second end 212 and extends away from axis X at a second angle. The first angle of shoulder 213 may be greater or lesser than the angle of shoulder 214. In the illustrated example, the angle of shoulder 213 with respect to axis X is less than the angle of shoulder 214 with respect to axis X.

At least one recess 215 is provided in a side of the pin 210. As will be described in relation to later figures, this is for receiving one or more radially extending features 235, 236 of retaining portion or portions 233,234 of the spacer member 230. Spacer member 230 may comprise one or more spacer portions 231, 232 which extend radially from the common longitudinal axis X shared by the pin 210 and the spacer member 230 when assembled together, as will be described in relation to later figures.

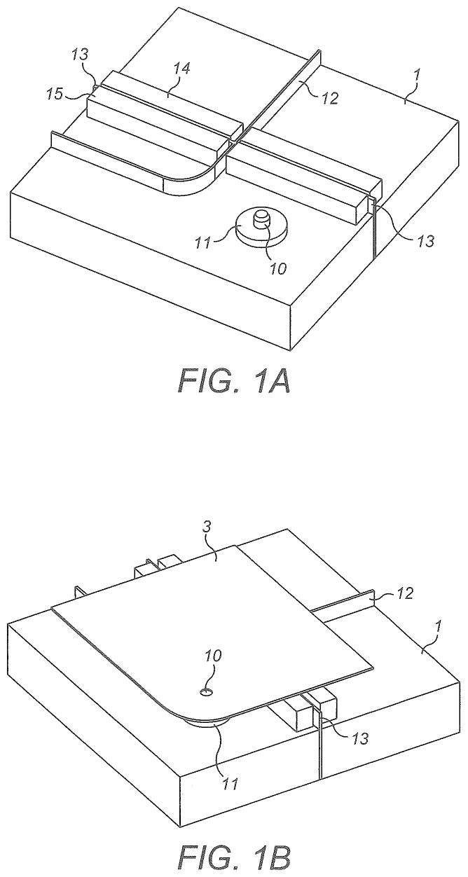

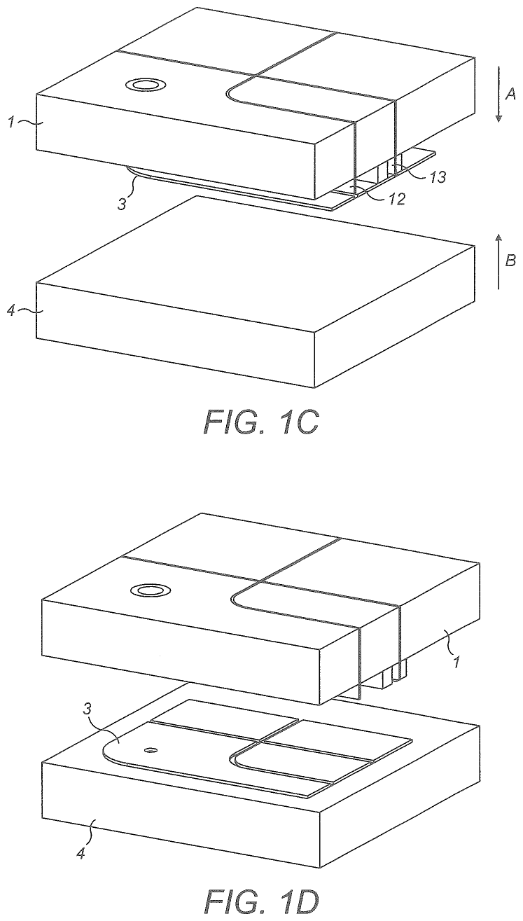

In addition to the spacer portion or portions 231, 232, the spacer member 230 may comprise one or more retaining portions 233, 234. These retaining portion(s) are configured for retaining the spacer member to the eventual assembly of alignment pin 210, spacer member 230 and mounting body 260. The retaining portion or portions 233, 234, may comprise one or more outward radial projections 237 and 238 and one or more inward radial projections 235 and 236. As will be clear from later assembly drawings, these projections can act to retain the overall assembly in an assembled state, while allowing movement of the alignment pin 210 and/or space member 230, between different assembled positions. The spacer portion or portions 230, 231 are generally configured to extend radially outward from the pin 210. A first surface 239 of the spacer portion faces away from the mounting body 260 and can generally act as a bearing surface against which the counterplate 3 can bear when the alignment device 200 is used in the methods described in relation to FIGS. 1A to 1D. The spacer member 230 is generally arranged to take the place of the resilient spacer 11 shown in FIGS. 1A to 1D. It therefore comprises a central opening for receiving the, alignment pin 210, and the first surface 239, which is configured to face the counterplate 3 when the alignment device 200 is located in the die board 1. The system described in FIG. 2A can also include a separate setting tool 280. The setting tool 280 can comprise one or more circumferentially extending hooks 281, 282, and these can be configured to engage a second surface 240 of the spacer member, which surface is generally oriented towards the mounting body 260 of the device 200. Hooks 281 and 282 may be configured to pass through notches 241 and 242 in the spacer member in order to engage the second surface 240. As will be appreciated, rotation of the tool 280 after passing the hooks through the notches can engage the hooks with the surface 240 of the spacer member 230.

When assembled, the alignment pin 210 and the spacer member 230 are at least partially received within the mounting body 260. The illustrated mounting body 260 has a generally substantially cylindrical form, but other forms can perform the core function of the mounting body, which is to allow the alignment pin 210 to be retained in its two function positions, the first being an extended position where the pin is extended out from a first end 261 of the mounting body, the second being a retracted position, in which the pin is at least partially retracted back into the mounting body 260, at least so as to protrude from the mounting body to a lesser degree than when in its extended position. The mounting body 260 preferably comprises one or more resilient engagement members 262 and 263, which can engage the second shoulder 214 of the alignment pin 210 to retain the pin 210 in its extended position. When the pin is in its extended position, the spacer member 230 can also be considered to be in an extended position, with the surface 239 extended away from the mounting body 260 to a greater degree than when the pin and spacer member are in a retracted position.

FIG. 2B shows the spacer member 230 mounted to the pin 210. In the illustrated configuration, the spacer member 230 is in a first, advanced, position on the alignment pin 210 in which the first surface 239 of the spacer member is advanced towards, and preferably aligned with, the first end 211 of the alignment pin 210. The first and second radially inwardly projecting portions 235 and 236 can prevent the spacer member from extending beyond the end 211 of the alignment pin 210 in this direction, by engagement with either or both of recesses 215 and/or 216.

FIG. 2C shows the spacer member 230 mounted to the alignment pin 210 in a second, retracted position, in which the surface 239 of the spacer member is retracted behind the first end 211 of the alignment pin 210. When is this position, the retaining portion(s) 233, 234 is/are biased outwardly, radially away from the longitudinal axis X by engagement with first shoulder 213 of the alignment pin 210. As will be appreciated, the further down in the direction of arrow C the spacer member 230 is pressed, the greater the outward biasing of the retaining portions 233 and 234 will be. Since the retaining portions 233 and 234 are biases inwardly toward the axis X, the spacer member 230 is biased towards the first end 211 of the alignment pin and away from s second end 212 by interaction of the retaining members with the first shoulder 213. When the alignment pin 210 is in a retracted position within the mounting body 260, the spacer is free to occupy and move between the advanced position of FIG. 26, or the retracted position of FIG. 2C. The biasing of the spacer member 230 towards the first end 211 of the alignment pin provides a resilient force and so, when installed in the die board 1 of FIG. 1A, the spacer member 230 can mimic the biasing force of the resilient spacer 11 shown in FIG. 1A. This is a preferred way of biasing the spacer member toward the first end 211 of the pin 210, although other methods of biasing the spacer member axially along the axis X of the pin 210 can be envisaged.

FIG. 2D shows further detail of the mounting body 260, where an optional inner step 264 can be identified, preferably comprising one or more inner openings 265 for receiving the “legs” or retaining portions 233 and 234 of the spacer member 230.

FIGS. 2E, 2F and 2G show different views of the alignment advice with the alignment pin 210 in its extended position. As can be seen, in this configuration, the alignment pin 210 is biased into its extended position by an interference fit (shown by an overlap) between the second shoulder 214 of the pin 210 and the engagement members 262 and 263 of the mounting body 26. Further, when the pin 210 is biased into this position, the spacer member 230 is substantially fixed in the retracted position of FIG. 2C, relative to the alignment pin 210. This is because the retaining portions of the spacer member 230 are substantially fixedly compressed between the first shoulder 213 of the alignment pin and a radially inward projecting surface 267 of the mounting body 260, which can engage one or both of the radially outward projecting portions 237 and/or 238 of the retaining portion(s) of the spacer member 230.

As will be appreciated, particularly from FIG. 2F, whether the alignment pin 210 is in the extended position shown in FIG. 2F or in a retracted position, with the shoulders 214 and 213 of the pin below the engagement members 262 and 263, the inward projections 235 and/or 236 of the retaining portion(s) of the spacer member 230 can be provided to prevent the alignment pin 210 from exiting the mounting body in a direction of arrow D. Further, either or both of the outwardly projecting portions 237 and 238 of the retaining portion(s) of the spacer member can be provided to prevent either or both of the spacer member and the alignment pin 210 from exiting the mounting body 260 in a direction of arrow E of FIG. 2F.

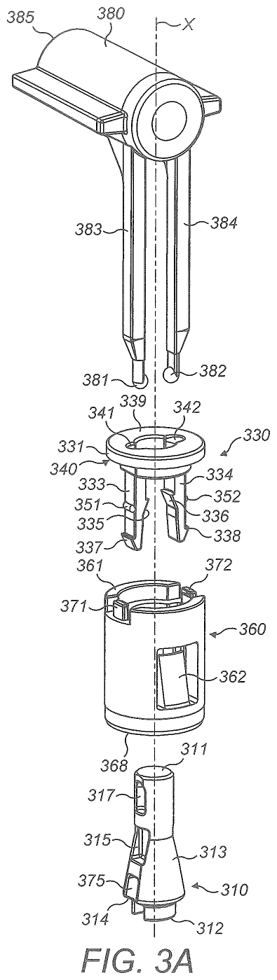

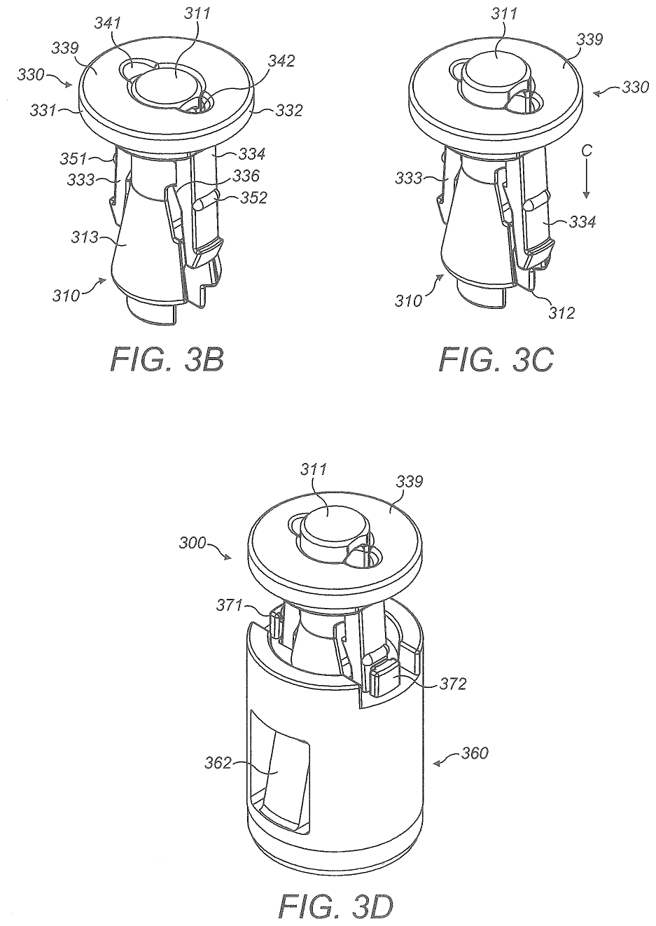

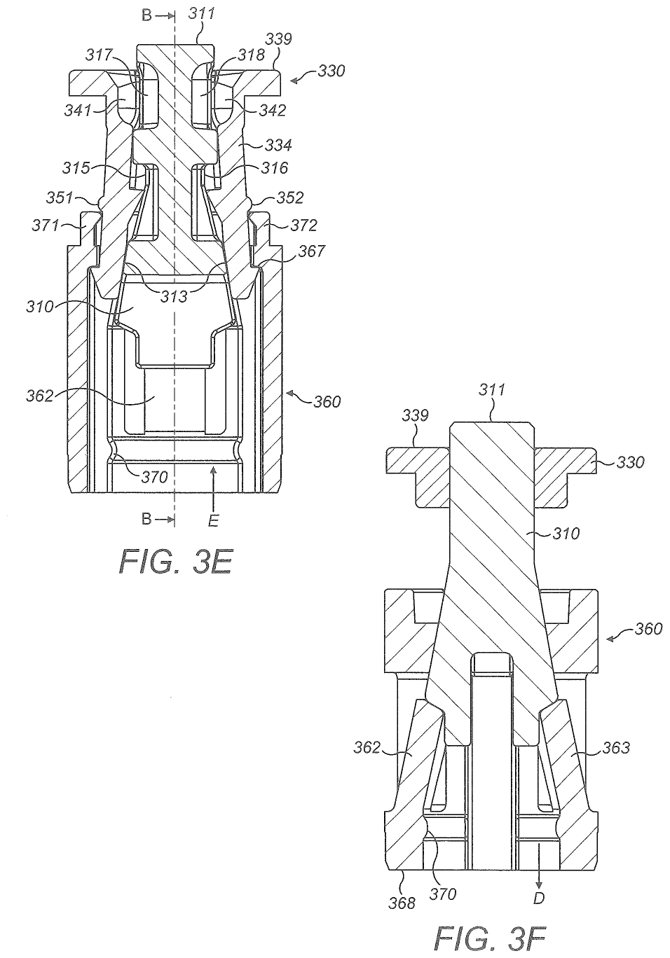

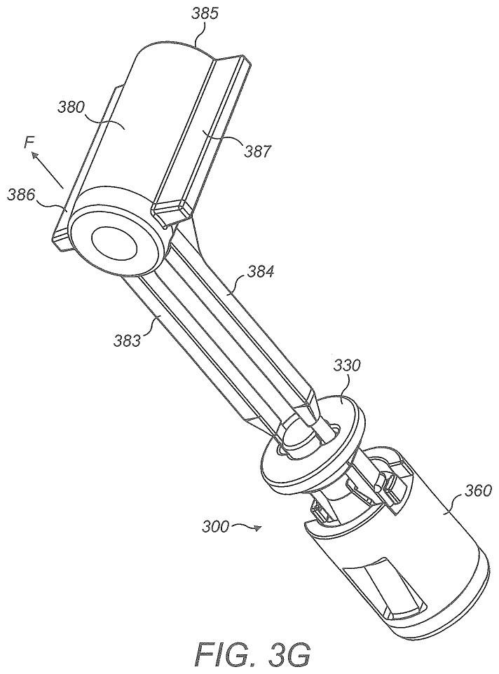

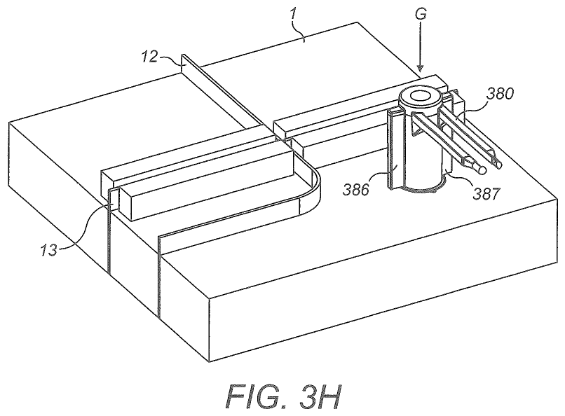

The assembly allows the alignment pin 210 to be biased into the extended position of FIGS. 2E to 2G, and retained and place by engagement members 262 and 263 of the mounting body 260. As will be appreciated, when a sufficient force is applied to the alignment pin 210 and/or the spacer member 230 in a direction of arrow D of FIG. 2G, i.e. in a direction toward the second end 212 of the alignment pin 210, then the biasing force of the engagement members 262 and 263 can be overcome, and the alignment pin 210 will be moved to a position where the shoulder 214 is below the engagement members 262 and 263. This can be considered a retracted position of the alignment pin 210. The alignment pin 210 will generally be prevented from passing a position where the second end 212 is aligned with the bottom end 268 of the mounting body 260. This may be achieved by the pin 210 resting on a surface which is aligned with the bottom end 268, i.e. a surface of the die board 1. Alternatively, this may be achieved by providing a suitable lip or projection on the inner surface of the mounting body 260 to limit the movement of the pin 210 in a direction of arrow D, as will be shown in relation to FIGS. 3A to 3H. This position of the pin will cause the first end 211 of the pin 210 to stand proud of the top of the mounting body 260, and, as illustrated in FIGS. 2B and 2C, the spacer member 230 will be biased into the advanced position shown in FIG. 2B, where the surface 239 is biased towards the first end 211 of the alignment pin 210.

These extended and retracted positions of the alignment pin 210 and spacer member 230 can now be explained in the context of the process illustrated in FIGS. 1A to ID. For the step illustrated in FIG. 1A, the mounting body 260 is mounted in the die board 1 and the setting tool 280 can be used to draw the pin 210 and spacer member 230 into the extended position illustrated in FIGS. 2E to 2G.

In the step of FIG. 1B, the counterplate 3 can be mounted to the die board and aligned onto the first end or ends 211 of one or more alignment pins 210 provided in the die board for alignment purposes. The spacer member 230, being held in fixed relation to the first end 211 of the alignment pin 210, holds the counterplate at a suitable spacing from the die plate, while the pin 210 provides the alignment function. In the step illustrated in FIG. 1C, the counterplate board 4 and the die board 1 are brought together in the direction of arrows A and B as illustrated in FIG. 1C. When the counterplate comes into contact with the counterplate board 4, the spacer member 230 will provide a compressive force via its counterplate-facing surface 239, until such point time as the biasing force of the engagement members 262 and 263 of the mounting body is overcome by the compressive force of the counterplate board on the counterplate 3. By this action, a compressive force will have been applied by the spacer member 230, until such time as that is overcome by the force of the counterplate board in the direction of arrow D of FIG. 2G. After that point, the pin 210 will be pressed back into its retracted position, and the biasing force towards the advanced position of FIG. 2B will remain in place, providing an additional resilient force, biasing the counterplate 3 onto the counterplate board 4.

Once this process is complete, the alignment pin 210 is now retracted within the mounting body 260. Then the pin 210 protrudes from the spacer member 230, but sits sub-flush relative to the blades 12, 13, or, otherwise stated the pin first end 211 remains between the outer edge of the blades 12, 13, and the surface of the die board 1. The spacer member 230 can then provide a surface against, which sheets to be stamped in the die may rest, with the pin 210 protruding from it. However, the pin may sit sufficiently low in the die board that it is completely clear of the sheets to be cut and creased during the manufacturing operation. Therefore, the manufacturing operation can continue without any need to remove the alignment pin or pins 210, nor any resilient spacer member 11, which had to be removed in the prior art process illustrated and described in FIGS. 1A to 1D.

Further, if the process needs to be reconfigured to use a new counterplate to align with a new die, the alignment devices in the system can simply be reset with the setting tool 280, and there is no need to reinstall any pins 10, nor any resilient spacers 11, as would otherwise be the case in the prior art process described in FIGS. 1A to 1D.

FIGS. 3A to 3F show an alternative embodiment 300 of an alignment device. The arrangement and functioning of the device 300 is in many respects equivalent to that of the embodiment shown in FIGS. 2A to 2G. For example, the pin 310 can move between its extended and retracted positions in the same manner as the pin 211 in FIGS. 2A to 2G. The engagement of pin 310 with spacer member 330 to create the biased movement between the pin 310 and the spacer member 330 is equivalent to that described in relation to FIGS. 2B and 2C and, in a general sense, the device can be incorporated into the process illustrated in FIGS. 1A to 1D in the same manner as described in relation to the earlier embodiment of FIGS. 2A to 2G. Equivalent features in FIGS. 3A to 3F are given the same numerals as those in FIGS. 2A to 2F, but with the first digit being a 3 instead of a 2.

The primary differences between the embodiment of FIGS. 3A to 3F and FIGS. 2A to 2G lie in a number of areas, including: the provision of one or more tool engagement recesses 317 and 318 towards the first end 311 of the pin 310; the provision of one or more secondary engagement portions, 371, 372 on the mounting body, with one or more corresponding engagement projections 351 and 352 on the retaining portion(s) of the spacer member 330; a further retaining projection 370 inside the bore of the mounting body 360; and a different configuration of setting tool 380, These features will be described in more detail in the following, while other features can be considered equivalent to those described in relation to FIGS. 2A to 2G.

As illustrated in the FIGS. 3A and 3E, one or more tool engagement recesses 317, 318 is provided toward a first end 311 of the pin 310. This recess or recesses comprises at least one substantially radially projecting surface, oriented towards the second end 312 of the pin 310. This surface allows a projection or projections 381 and/or 382 of the setting tool 380 to engage that surface in order draw the pin 310 in a longitudinal direction away from the mounting body, as illustrated by arrow E in FIG. 3E. This enables the tractive force of the setting tool 380 to be provided directly to the pin 310, which can avoid the stresses induced in the spacer member 330 when drawing the pin via the spacer member 230 of the embodiment of FIGS. 2A to 2G. This can allow the spacer member 330 to be made from less material and to be of more efficient construction. This further enables the pin 310 to be drawn up to a higher position than the spacer member 330 during the setting operation.

Radially inwardly facing reassess 341 and 343 can also be provided in spacer member 330. These can provide sufficient space for the projection or projections 381 and 382 of the setting tool 380 to pass around the first end 311 of the pin and into the tool engagement recesses 317 and/or 318. These reassess 341 and 341 are optional, but in their absence, the bore of the spacer member 330 would have to otherwise provide sufficient space between the pin 310 and the inner bore of the opening in the spacer member 330, to allow passage of the relevant portions of the setting tool 380 into the engagement recesses 317/318.

A further optional feature which may be included in the embodiment shown in FIGS. 3A to 3F is the additional secondary engagement portions 371 and 372. One or more such features may be provided to provide an additional holding force, holding the spacer member 330 in its extended position when the pin 310 is in its extended position in the mounting body 360. This can be seen in, for example, FIGS. 3D and 3E. In particular, the secondary engagement portion 371, is lodged below the engagement projection 351 of the spacer member and so it is necessary to bias the engagement member 371 radially outward to allow the projection 351 to pass downward in the direction of arrow D, in order to retract the pin 310 and the spacer member 330 to their retracted positions. Similarly, the same effect can be provided via projection 355 contacting a further secondary engagement portion 372 on a further retaining portion 334 of the spacer member 330. Direct engagement of the spacer member 330 with the mounting body 360 can therefore be implemented to retain the pin 310 and spacer member 330 in their respective extended positions.

Therefore, in the embodiment illustrated in FIGS. 3A to 3F, the force required to move the spacer member 330 and pin 310 from their extended position to their retracted positions can be increased. This can help to increase the biasing force provided by the spacer member 330 to press the counterplate onto the counterplate board in the step illustrated in FIG. 1C. As will be appreciated, the size and strength of the engagement portions 371, 372 and projections 351, 352 can be varied to vary the overall force required to be applied to the spacer member 330 in order to retract the spacer member 330 and pin 310 within the mounting body 360.

As can be seen in FIGS. 3E and 3F, an optional radially inward projection 370 can be provided within the mounting body 360. This is preferably arranged to engage the second shoulder 314 of the pin 310, to assist with retaining the pin 310 within the body 360. This can hold the pin 310 at a set retracted position within the mounting body by hindering its passage out of the mounting body 360 in a direction of arrow D. This can help to provide a pre-set retracted position via the features of the mounting body, rather than relying on the second end 312 of the pin 310 resting on any surface of any secondary element as optionally described in relation to FIGS. 2F and 2G. This can improve the reliability and repeatability of the operation of the alignment device 300.

Turning to the setting tool 380, as can be seen, it comprises one or more arms 383 and 384, and at an end of one or more of the arms is provided a radially inwardly extending projection 381 and 382. These inward projections generally comprise a substantially inwardly extending surface configured to be oriented towards a first end 311 of the pin 310, such that it can engage the surface of one or more of the tool engagement recess 317 and/or 318 which is oriented substantially towards the second end 312 of the alignment pin 310. In the illustrated embodiment, the projections are substantially rounded, or substantially part-spherically formed. However, any substantially straight or curved surface can be provided. It can be advantageous to provide the curved surfaces illustrated, since this can assist with easy passage of the tip or tips of the tool 380 into the recess or recesses 317, 318. In the illustrated configuration, where there are two or more substantially opposed projections 381, 382, the tool can be advantageously “pinched” by a user, or by automated means, to provide a gripping force on the pin 310, which assists with ensuring correct engagement of the tool with the pin 310 in order to draw it axially away from the mounting body 360 to move the pin to its extended position.

The setting tool 380 is also provided with a spacer member engagement portion 385. This portion is configured to engage the spacer member 330 in order to press the spacer member into the mounting body. This may be required, for example, if it is no, longer required to have the device in the extended configuration, or in any instance where manual placing of the pin and spacer member 330 in the retracted positions is desirable. The spacer member engagement portion 385 may be provided with an opening or recess configured to correspond with the first end 311 of the pin when in its extended position, such that any force provided by the tool when pressed is provided to the spacer member 330 rather than to pin 310.

As can be seen in the embodiments of FIGS. 2A to 2G and 3A to 3F, a void 275, 375, can be provided adjacent the second end 212, 312 of the pin 210, 310, since it is possible to create the pin with sufficient strength and structure without material in this region and this therefore reduces the amount of material required to manufacture the pin 210, 310.

FIG. 3G illustrates the setting tool 380 in an engaged configuration with the alignment device 300 and, as will be appreciated from the earlier figures, a tractive force provided in the direction of arrow F can be used to pull the pin 310 and spacer member 330 to their extended positions in order to set the alignment device, ready for the steps described in relation to FIGS. 1B and 1C.

FIG. 3H illustrates how the setting tool 380 can also be used to press the spacer member 330 and pin 310 into their retracted positions by applying a force in a direction of arrow G of FIG. 3H. At least one, part of the spacer member engagement portion 385 may extend laterally away from the body of the setting tool 380 so as to extend beyond an edge of the spacer member 330 when engaging the spacer member 330. This can be used to prevent the tool from pushing the device 300 into the die board too far. if extending flush with the spacer member engagement portion, this can prevent the device 300 from being pushed sub-flush in, or below the surface of, the die board 1. The setting tool 380 may therefore have one or more projecting portions, such as fins 386 and 387, to provide this effect, although a variety of precise forms of projection can provide this function. As described above, this can be used to retract the pin and spacer member, for example, in the event of inadvertent setting of the device to the extended configuration, or, for example, if the device fails to properly retract during the set up operation illustrated in FIGS. 1A to 1D.

Although the invention has been described above with reference to one or more preferred embodiments, it will be appreciated that various changes or modifications may be made without departing from the scope of the invention as defined in the appended claims.

1. An alignment device for aligning a counterplate with a die plate, comprising an alignment assembly, the alignment assembly comprising:
an elongate alignment pin having a first end, a second end and a longitudinal axis extending between the first and second ends;
a mounting body, the alignment pin being disposed in the mounting body;
a spacer member, comprising:
a spacer portion extending radially from the alignment pin; and
a retaining portion for retaining the spacer member to the assembly;
the alignment pin, spacer member and/or mounting body being configured such that the alignment pin is retained in the mounting body in a first, extended, position, and in a second, retracted, position;
wherein the spacer member is retained to the assembly in both the extended and retracted positions of the alignment pin.

2. The alignment device according to claim 1, wherein, when the alignment pin is arranged in the retracted position, the spacer member is slideably retained to the assembly and is translatable along the longitudinal axis of the alignment pin.

3. The alignment device according to claim 1, wherein, when the alignment pin is arranged in the retracted position, the spacer member s biased away from the mounting body.

4. The alignment device according to claim 1, wherein, when the alignment pin is arranged in the retracted position, the retaining portion of the spacer member is configured to bias a first side of the spacer member away from the mounting body.

5. The alignment device according to claim 1, wherein, when the alignment pin is in its extended position, the spacer member is held in substantially fixed position relative to the alignment pin and/or the mounting body.

6. The alignment device according to claim 1, wherein the retaining portion of the spacer member is configured to retain the spacer member to the assembly and to retain the alignment pin within the mounting body.

7. The alignment device according to claim 1, wherein the retaining portion of the spacer member is configured to be located radially between the alignment pin and the mounting body.

8. The alignment device according to claim 1, wherein, when arranged in the retracted position of the alignment pin, the retaining portion of the spacer member is configured to bias the first side of the spacer member away from the mounting body by biasing against a first shoulder on the alignment pin.

9. The alignment device according to claim 1, wherein, when arranged in the extended position of the alignment pin, the alignment pin is biased into the extended position by one or more biasing members of the mounting body acting on a second shoulder of the alignment pin.

10. The alignment device according to claim 1, wherein the retaining portion of the spacer member is configured to retain the spacer member to the alignment pin.

11. The alignment device according to claim 1, wherein the retaining portion of the spacer member is configured to retain the spacer member to the alignment pin by a first substantially radially extending feature of the retaining portion engaging a corresponding substantially radially extending feature of the alignment pin.

12. The alignment device according to claim 1, wherein the retaining portion of the spacer member is configured to retain the spacer member to the alignment pin by a second substantially radially extending feature of the retaining portion engaging a corresponding substantially radially extending feature of the mounting body.

13. The alignment device according to claim 1, wherein the spacer member and/or the alignment pin comprises an engagement portion configured to be engaged by a setting tool to draw the spacer and/or alignment pin away from the mounting body to place the alignment pin in the extended position.

14. The alignment device according to claim 1, wherein the alignment pin comprises an engagement surface configured to be engaged by a setting tool to pull the alignment pin away from the mounting body to place the alignment pin in the extended position.

15. The alignment device according to claim 1, wherein the spacer member comprises secondary retaining means, configured to retain the assembly in the extended position.

16. The alignment device according to claim 15, wherein the secondary retaining means comprises at least one projection on the retaining portion of the spacer member, configured to engage an engagement member of the mounting body.

17. A system comprising an alignment device according to claim 1, and a setting tool, configured to engage an engagement portion or surface of the alignment pin and/or the spacer member to pull the alignment pin and/or spacer member into the extended position.

18. (canceled)

19. (canceled)

20. An alignment device for aligning a counterplate with a die plate, comprising an alignment assembly, the alignment assembly comprising:
an elongate alignment pin having a first end, a second end and a longitudinal axis extending between the first and second ends;
a mounting body, the alignment pin being disposed in the mounting body;
the alignment pin and mounting body being configured such that the pin can be retained in the mounting body in a first, extended, position, and in a second, retracted, position;
wherein the alignment pin comprises an engagement surface configured to be engaged by a setting tool to pull the alignment pin away from the mounting body to place the alignment pin in the extended position.

21. A method of aligning a counter plate with a die for cut and crease manufacturing operations, comprising the steps of:
a) providing one or more alignment devices projecting from a blade side of a die board, the alignment device comprising an alignment pin retained in a mounting body, the alignment pin and mounting body configured such that the alignment pin can be retained in a first, extended, position, and in a second, retracted, position;
b) aligning a counterplate over the die by alignment with the alignment pin;
c) actuating a press to press the counterplate onto a counterplate board, the force of the press moving the alignment pin from its extended position to its retracted position; and
d) pulling the alignment pin from a blade side direction, to place it in its extended position, after using the counter plate and die to cut and crease one or more sheets.

22. The method according to claim 21, wherein the alignment pin is the alignment pin according to claim 1.
